(19) United States
(12) Patent Application Publication
(10) Pub. No.: US 2015/0153696 A1
(43) Pub. Date: Jun. 4, 2015

(54) IMAGE FORMING APPARATUS, METHOD FOR CONTROLLING THE IMAGE FORMING APPARATUS, AND STORAGE MEDIUM

(71) Applicant: CANON KABUSHIKI KAISHA, Tokyo (JP)

(72) Inventor: Hiroshi Oya, Kawasaki-shi (JP)

(21) Appl. No.: 14/557,255

(22) Filed: Dec. 1, 2014

(30) Foreign Application Priority Data
Dec. 4, 2013 (JP) 2013-251396

(51) Int. Cl. G03G 15/08; G03G 15/00

(52) U.S. Cl. CPC G03G 15/5016

(57) ABSTRACT

There is provided an image forming apparatus in which a toner consumption coefficient is determined in accordance with a type of a job, and an amount of consumed toner is calculated based on the number of pages in the job and the determined toner consumption coefficient.

### BACKGROUND

1. Field

Aspects of the present invention generally relate to an image forming apparatus, a method for controlling the image forming apparatus, and a storage medium.

2. Description of the Related Art

Image forming apparatuses use a recording material such as toner to perform image forming on a sheet. Generally, the recording material is contained in a container such as a cartridge. Some image forming apparatuses detect a remaining amount of the recording material in the container and display a value of the amount on a display unit such as a user interface (UI).

Conventionally, the image forming apparatus has been provided with a sensor to detect a value of the remaining amount of the recording material, and the detected vale has been directly displayed as the remaining amount of the recording material. In many cases, in consideration of cost and other factors, a sensor to be employed may not be able to perform the detection accurately until the remaining amount drops to a certain level. Such a sensor detects the remaining amount of the recording material as one of discrete values, such as, 100%, 20%, and 0%. As a result, the display unit also displays the remaining amount of the recording material as one of the discrete values, such as 100%, 20%, and 0%.

Japanese Patent Application Laid-Open No. 2006-343621 discusses a technique in which the remaining amount of the recording material is displayed on the display unit as one of continuous values, while employing the sensor that detects the remaining amount as one of the discrete values. For example, when the image forming is executed, a prediction value of a toner consumption amount is calculated based on a dot count value of raster data, and a prediction value of the remaining toner amount is calculated based on the toner consumption amount. The resultant value is displayed as a current value of the remaining toner amount. When a sensor value of the remaining toner amount is acquired from the sensor, the current value is updated with the sensor value.

Some low price image forming apparatuses do not have a dot count function, and thus cannot use the dot count value to predict the toner consumption amount.

Such an image forming apparatus may predict the toner consumption amount based on the number of pages in a job. More specifically, the toner consumption amount is predicted by multiplying the number of pages in the job by a certain toner consumption coefficient.

However, in this method, the toner consumption amount is predicted by using a value of the toner consumption coefficient assuming that the toner consumption amount per page is the same among jobs of any types, and thus accuracy of the toner consumption amount prediction might be low.

### SUMMARY

Aspects of the present invention are generally directed to a technique for improving accuracy in processing of predicting a toner consumption amount based on the number of pages in a job.

An image forming apparatus according to an aspect of the present invention is configured to execute image forming by using a recording material, and includes an input unit configured to input a job, a checking unit configured to check a type of the job input by the input unit, a determination unit configured to determine a coefficient used to calculate a prediction value of an amount of the recording material consumed in the job, in accordance with the type of the job checked by the checking unit, an extracting unit configured to extract a number of pages on which the image forming is executed in the job input by the input unit, and a calculation unit configured to calculate, based on the number of pages extracted by the extracting unit and the coefficient determined by the determination unit, the prediction value of the amount of the recording material consumed in the job.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of an image forming apparatus.

FIG. 2 is a block diagram illustrating a configuration of a controller.

FIG. 3 is a block diagram illustrating a configuration of a print engine.

FIG. 4 is a flowchart illustrating control for detecting a remaining toner amount (first half).

FIG. 5 is a flowchart illustrating the control for detecting the remaining toner amount (second half).

FIG. 6 is a graph illustrating transition of a current value of the remaining toner amount.

FIG. 7 (including FIGS. 7A and 7B) is a flowchart illustrating processing of calculating a prediction value of a toner consumption amount in detail according to a first exemplary embodiment.

FIG. 8 is a table illustrating a correspondence relationship between a job type and a toner consumption coefficient.

FIG. 9 is a block diagram illustrating a configuration of a data processing apparatus.

FIG. 10 (including FIGS. 10A and 10B) is a flowchart illustrating processing of calculating a prediction value of a toner consumption amount in detail according to a second exemplary embodiment.

FIG. 11 is a table illustrating a correspondence relationship between a job type and a toner consumption coefficient according to the second exemplary embodiment.

### DESCRIPTION OF THE EMBODIMENTS

Exemplary embodiments will be described below with reference to the drawings.

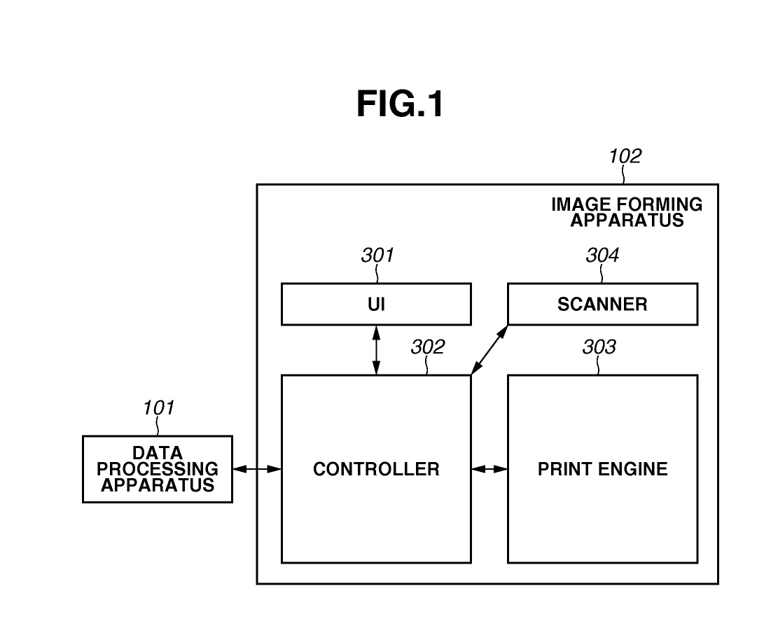

FIG. 1 is a block diagram illustrating a configuration of an image forming apparatus 102 according to a first exemplary embodiment.

A data processing apparatus 101 (e.g., personal computer (PC)) generates image data and transmits the image data to the image forming apparatus 102.

The image forming apparatus 102 (e.g., laser printer) receives the image data from the data processing apparatus 101 and executes image forming on a sheet based on the image data. The image forming apparatus 102 may be a multifunction peripheral with a scanner function, a FAX function, and the like.

A user interface (UI) 301 includes a display unit for providing various types of information to a user and an operation unit for receiving various operations from the user. The display unit displays a current value of a remaining toner amount as described below. The current value of the remaining toner amount may be transmitted to an external apparatus such as the data processing apparatus 101 via an external I/F 404, and displayed on a display unit of the external apparatus such as the data processing apparatus 101.

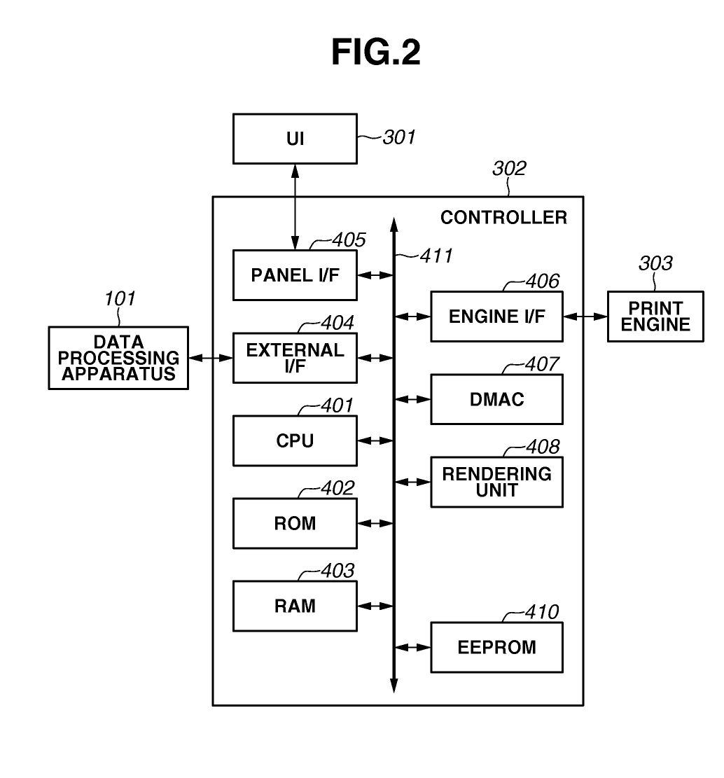

A controller 302, which will be described below in detail with reference to FIG. 2, generates bitmap data based on page description language (PDL) data, and transmits the bitmap data to a print engine 303.

The print engine 303 executes the image forming on a sheet by using the electrophotographic method, based on the bitmap data received from the controller 302. For example, the image forming may be executed by the inkjet method, instead of the electrophotographic method. A recording material used in the electrophotographic method is toner, whereas the one used in the inkjet method is ink.

A scanner 304 reads a document and inputs image data. The image data is used for copying or stored in a storage medium.

The controller 302 and the print engine 303, which are described as separate components, may be integrally formed.

FIG. 2 is a block diagram illustrating a configuration of the controller 302.

A central processing unit (CPU) 401 loads a program stored in a read only memory (ROM) 402 onto a random access memory (RAM) 403, and executes the program to control the image forming apparatus 102. The CPU 401 calculates the remaining toner amount based on a sensor value of the remaining toner amount notified from the print engine 303 as described below. The CPU 401 displays the remaining toner amount thus calculated on the UI 301 via a panel I/F 405. The CPU 401 further notifies the data processing apparatus 101 of the remaining toner amount via the external I/F 404.

The ROM 402 stores the program to be executed by the CPU 401.

The RAM 403 stores the program loaded from the ROM 402. The RAM 403 further stores PDL data, intermediate data generated by interpreting the PDL data, bitmap data generated by rendering the intermediate data, various temporal processing statuses and pieces of log information required for other processes or the like.

The external I/F 404 connects the data processing apparatus 101 and the controller 302 with each other, and relays bidirectional data communications, i.e., transmission and reception of data therebetween.

The panel I/F 405 connects the UI 301 and the controller 302 with each other, and relays bidirectional data communications, i.e., transmission and reception of data therebetween.

An engine I/F 406 connects the print engine 303 and the controller 302 with each other, and relays bidirectional data communications, i.e., transmission and reception of data therebetween.

A direct memory access controller (DMAC) 407 performs data access, i.e., writing and reading of data to and from the RAM 403, upon receiving an instruction from the CPU 401.

A rendering unit 408 renders the intermediate data into the bitmap data.

An electrically erasable programmable read only memory (EEPROM) 410 stores setting information of the image forming apparatus 102 or the like.

A bus 411 connects the components in the controller 302 with each other.

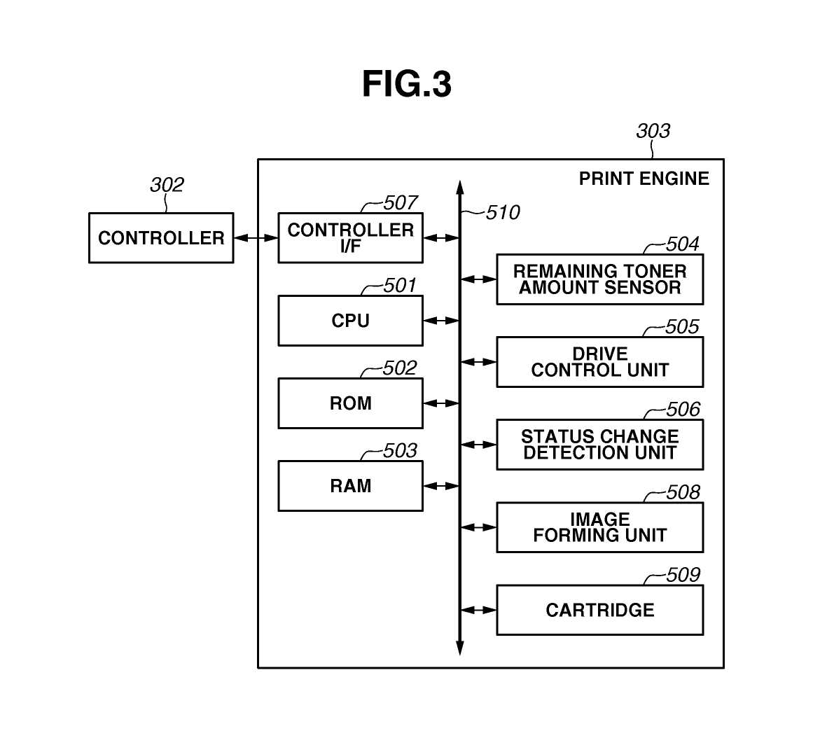

FIG. 3 is a block diagram illustrating a configuration of the print engine 303.

A CPU 501 loads a program stored in a ROM 502 onto a RAM 503 and executes the program to control the print engine 303.

The ROM 502 stores the program executed by the CPU 501.

The RAM 503 stores the program loaded from the ROM 502.

A remaining toner amount sensor 504 detects a remaining toner amount in a cartridge 509. As a method for detecting the remaining toner amount with a sensor, there are methods using, for example, magnetic permeability, magnet, piezoelectric vibration, and transmitted light. When the remaining toner amount drops to a predetermined value, such as 20% and 0%, the remaining toner amount sensor 504 detects the value as a sensor value. More specifically, the remaining toner amount within a range between 100% and 21% is detected as 100%. The remaining toner amount within a range between 20% and 1% is detected as 20%. The remaining toner amount of 0% is detected as 0%. The remaining toner amount sensor 504 may be arranged in the sensor cartridge 509.

A drive control unit 505 drives various motors required for image forming executed by an image forming unit 508.

A status change detection unit 506 detects a status change, such as a paper jam and an open cover, in the image forming apparatus 102. The status change detection unit 506 further detects that the cartridge 509 is replaced. Alternatively, the CPU 501 may detect the status change.

A controller I/F 507 connects the controller 302 and the print engine 303 with each other, and relays bidirectional data communications, i.e., transmission and reception of data therebetween.

The image forming unit 508 performs the image forming on a sheet by the electrophotographic method by using toner, based on the bitmap data received from the controller 302.

The cartridge 509 is a process cartridge that can be mounted to the image forming apparatus 102, as a container unit to contain the toner. The cartridge 509 stores the toner used by the image forming unit 508 for the image forming. The cartridge 509 includes a nonvolatile storage medium that stores cartridge information. The cartridge information includes information indicating whether the cartridge 509 is new, color information indicating the color of the cartridge 509, and remaining toner amount information indicating the remaining toner amount in the cartridge 509. The cartridge 509, which is connected to a bus 510, may be connected to the CPU 501 via a dedicated line.

The bus 510 connects the components in the print engine 303 with each other.

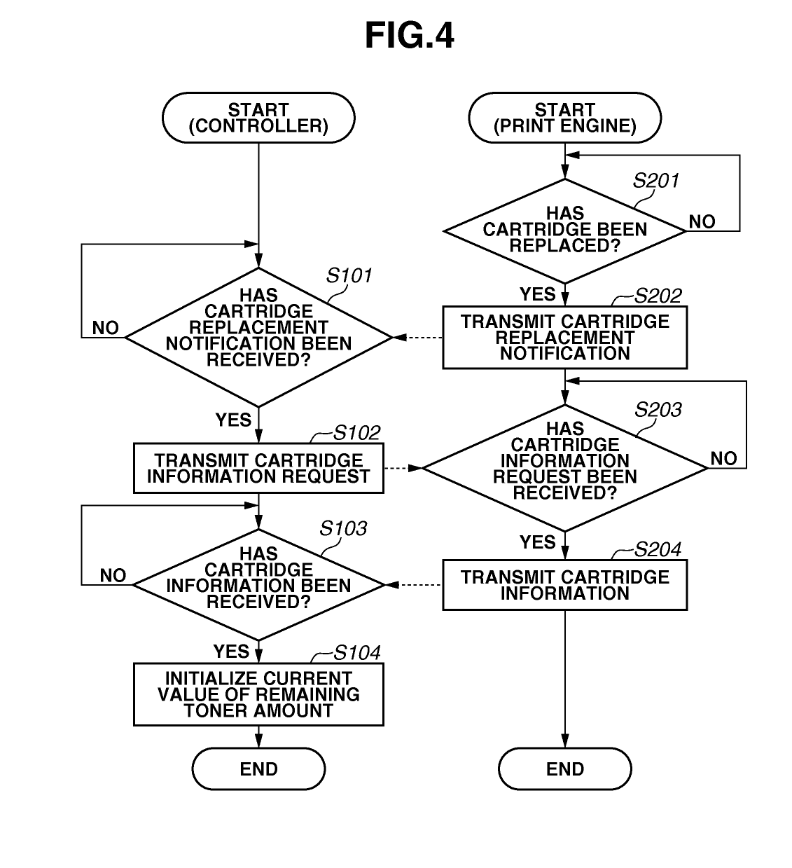

FIG. 4 is a flowchart illustrating control for detecting the remaining toner amount (first half).

The control illustrated in the left flowchart is implemented by the CPU 401 in the controller 302 loading a control program, which is stored in the ROM 402, onto the RAM 403 and executing the control program. The control illustrated in the right flowchart is implemented by the CPU 501 in the print engine 303 loading a control program, which is stored in the ROM 502, onto the RAM 503 and executing the control program.

First, in step S201, the CPU 501 determines whether the cartridge 509 has been replaced. The CPU 501 determines the replacement by detecting that the cartridge 509 has been newly mounted to the image forming apparatus 102. The CPU 501 recognizes that the cartridge 509 has been replaced when the status change detection unit 506 detects that the cartridge 509 has been mounted, and notifies it to the CPU 501. The status change detection unit 506 may determine that the cartridge 509 has been mounted by detecting opening or closing of a cover provided for replacing the cartridge 509. Alternatively, a hardware button or switch, which turns ON or OFF in accordance with attaching or detaching of a component, may be used for the determination. The processing proceeds to step S202 when the result of the determination in step S201 is YES, and stays in step S201 when the result is NO.

Subsequently, in step S202, the CPU 501 transmits a cartridge replacement notification, indicating that the cartridge 509 has been replaced, to the controller 302 via the controller I/F 507.

Subsequently, in step S101, the CPU 401 determines whether the cartridge replacement notification has been received from the print engine 303 via the engine I/F 406. The processing proceeds to step S102 when the result of the determination is YES in step S101, and stays in step S101 when the result is NO.

Subsequently, in step S102, the CPU 401 transmits a cartridge information request for requesting the cartridge information of the cartridge 509 to the print engine 303 via the engine I/F 406.

Subsequently, in step S203, the CPU 501 determines whether the cartridge information request has been received from the controller 302 via the controller I/F 507. The processing proceeds to step S204 when the result of the determination in step S203 is YES, and stays in S203 when the result is NO.

Subsequently, in step S204, the CPU 501 transmits the cartridge information of the cartridge 509 to the controller 302 via the controller I/F 507.

Subsequently, in step S103, the CPU 401 determines whether the cartridge information has been received from the print engine 303 via the engine I/F 406. The processing proceeds to step S104 when the result of the determination in step S103 is YES, and stays in step S103 when the result is NO.

Subsequently, in step S104, the CPU 401 initializes the current value of the remaining toner amount based on the cartridge information. The current value of the remaining toner amount is a value recognized by the controller 302 as the remaining toner amount in the cartridge 509, and is displayed to the user via the UI 301. The current value of the remaining toner amount is initialized as follows. The CPU 401 sets 100% as the current value of the remaining toner amount upon recognizing that the cartridge 509 is new by referring to the cartridge information. The CPU 401, not recognizing whether the cartridge 509 is new, sets a value corresponding to remaining toner amount information included in the cartridge information described above as the current value of the remaining toner amount. The current value of the remaining toner amount is stored in the RAM 403 or the like.

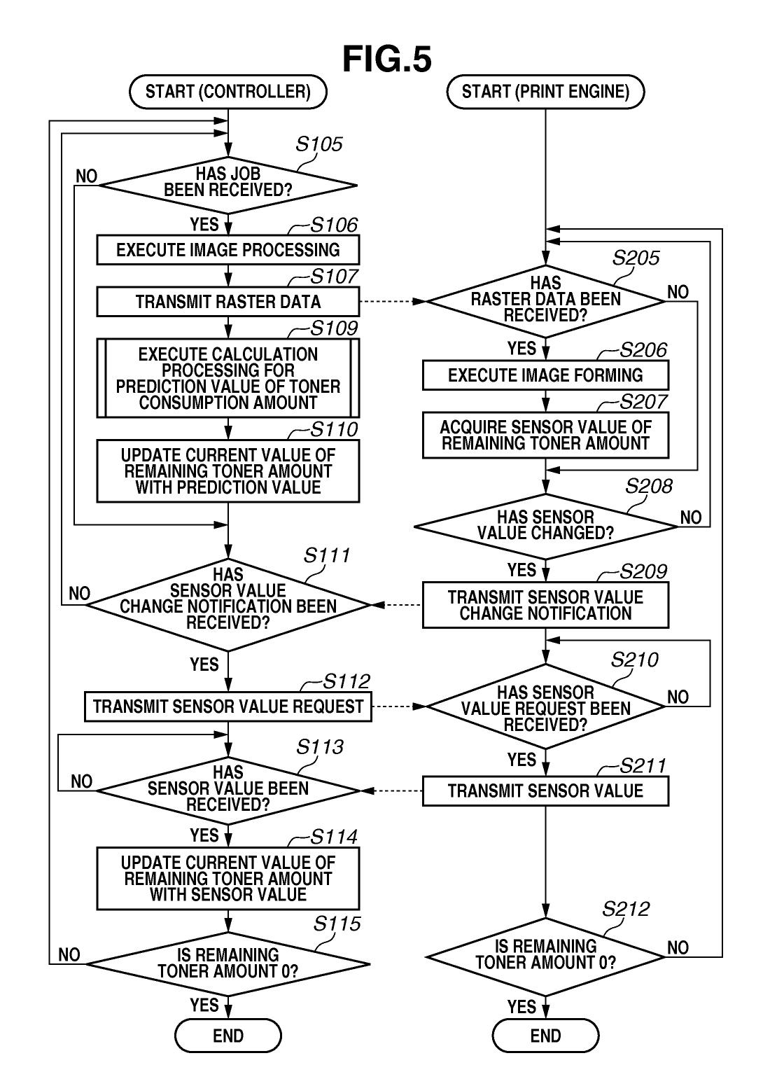

FIG. 5 is a flowchart illustrating control for detecting the remaining toner amount (second half).

First, in step S105, the CPU 401 determines whether a job involving the image forming has been received from the data processing apparatus 101 via the external I/F 404. Such a job includes a PDL print job, a copy job, and a FAX job. The processing proceeds to step S106 when the result of the determination in step S105 is YES, and proceeds to step S111 when the result is NO.

Subsequently, in step S106, the CPU 401 executes image processing required for the image forming based on the job. The image processing includes processing of rasterizing the print data to generate the raster data by controlling the rendering unit 408.

Subsequently, in step S107, the CPU 401 transmits the raster data generated by the image processing to the print engine 303 via the engine I/F 406.

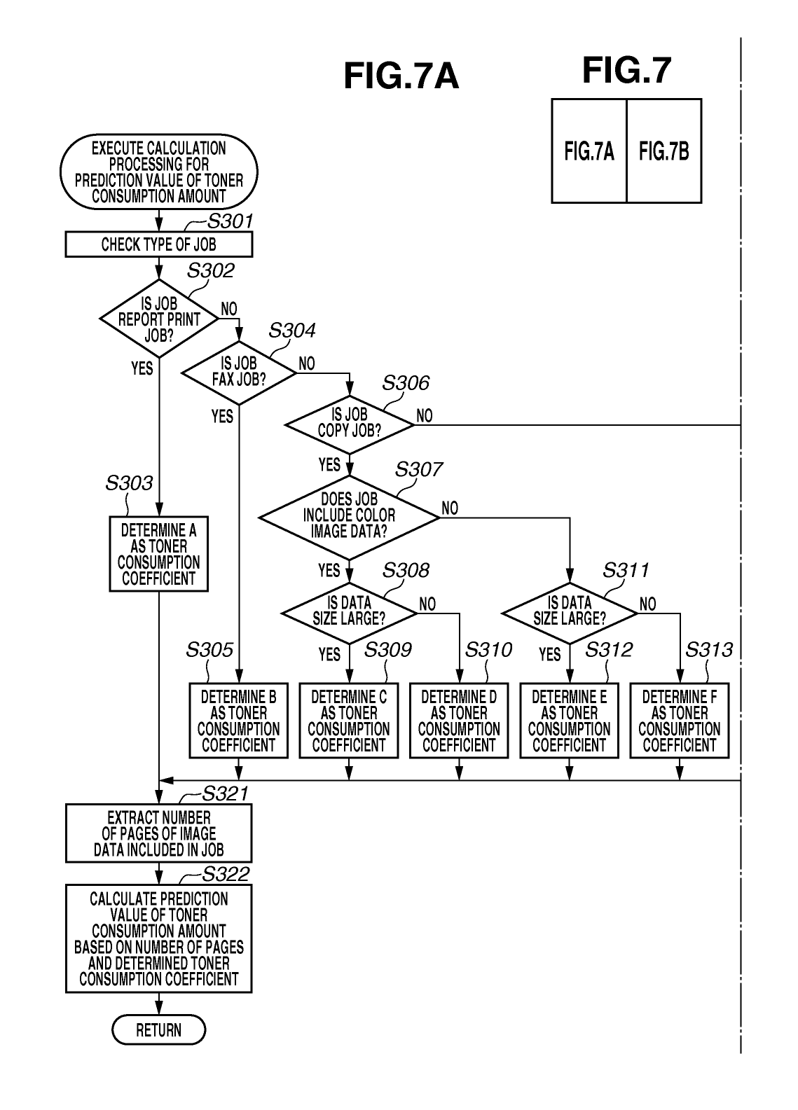

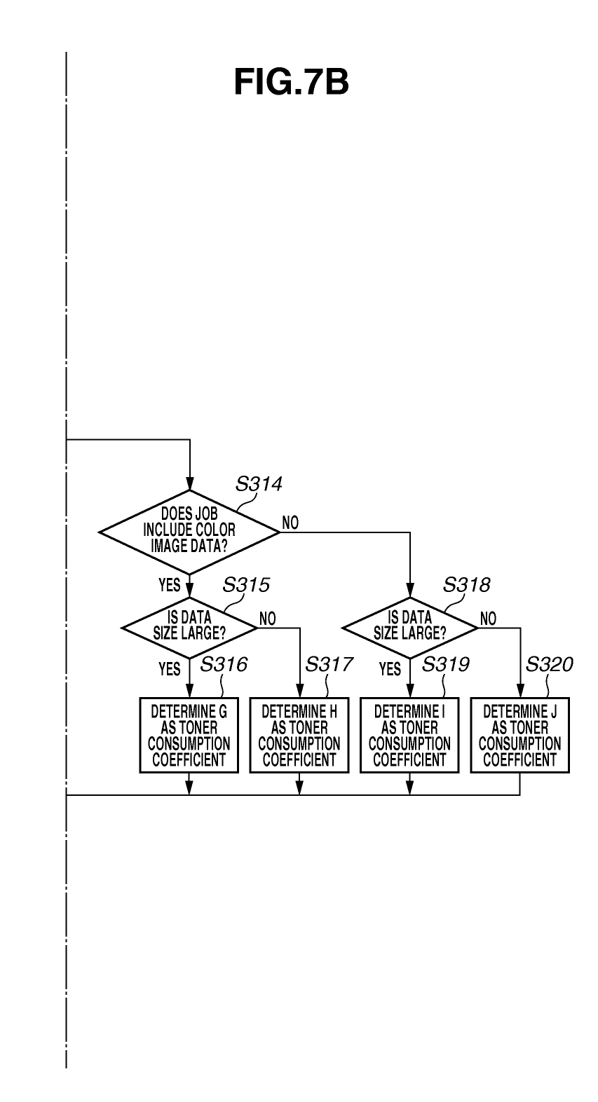

Subsequently, in step S109, the CPU 401 executes processing of calculating a prediction value of the toner consumption amount. The processing in Step S109 is described below in detail with reference to FIG. 7.

Subsequently, in step S110, the CPU 401 executes processing of updating the current value of the remaining toner amount based on the prediction value calculated in step S109. More specifically, the following calculations are sequentially performed: (current remaining toner amount [g])−(toner consumption amount [g] as a result of current job execution)=(new remaining toner amount [g]); and (new remaining toner amount [g])/(remaining toner amount [g] in unused cartridge)=(prediction value [%] of new reaming toner amount). The remaining toner amount in the unused cartridge may be stored in the ROM 402 or the ROM 502 in advance, or may be included in the cartridge information received in step S103. The prediction value [%] of the new remaining toner amount thus calculated is set as the current value of the remaining toner amount.

On the other hand, in step S205, the CPU 501 determines whether the raster data has been received from the controller 302 via the controller I/F 507. The processing proceeds to step S206 when the result of the determination in step S205 is YES, and proceeds to step S208 when the result is NO.

Subsequently, in step S206, the CPU 501 controls the image forming unit 508 so that the image forming is executed based on the raster data.

Subsequently, in step S207, the CPU 501 acquires the sensor value of the remaining toner amount from the remaining toner amount sensor 504. The sensor value may be acquired at a time when the image forming is completed on a page basis or on a job basis, or every time a predetermined period of time elapses.

Subsequently, in step S208, the CPU 501 determines whether the currently acquired sensor value has changed from the previously acquired sensor value. The processing proceeds to step S209 when the result of the determination in step S208 is YES, and returns to step S205 when the result is NO.

Subsequently, in step S209, the CPU 501 transmits a sensor value change notification indicating that the sensor value has changed to the controller 302 via the controller I/F 507.

Subsequently, in step S111, the CPU 401 determines whether the sensor value change notification has been received from the print engine 303 via the engine I/F 406. The processing proceeds to step S112 when the result of the determination in step S111 is YES, and returns to S105 when the result is NO.

Subsequently, in step S112, the CPU 401 transmits a sensor value request for requesting the sensor value to the print engine 303 via the engine I/F 406.

Subsequently, in step S210, the CPU 501 determines whether the sensor value request has been received from the controller 302 via the controller I/F 507. The processing proceeds to step S211 when the result of the determination in step S210 is YES, and stays in step S210 when the result is NO.

Subsequently, in step S211, the CPU 501 transmits the sensor value to the controller 302 via the controller I/F 507.

Subsequently, in step S113, the CPU 401 determines whether the sensor value has been received from the print engine 303 via the engine I/F 406. The processing proceeds to step S114 when the result of the determination in step S113 is YES, and stays in step S113 when the result is NO.

Subsequently, in step S114, the CPU 401 updates the current value of the remaining toner amount with the sensor value received in step S113. The currently acquired sensor value is stored in the RAM 403 or the like. When the previously acquired sensor value has been stored, the previously stored sensor value is updated with the currently acquired sensor value.

Subsequently, in step S115, the CPU 401 refers to the current value of the remaining toner amount to determine whether the remaining toner amount is 0. The processing is ended when the result of the determination in step S115 is YES, and returns to S105 when the result is NO.

On the other hand, in step S212, the CPU 501 refers to the sensor value of the remaining toner amount to determine whether the remaining toner amount is 0. The processing is ended when the result of the determination in step S212 is YES, and returns to S205 when the result is NO.

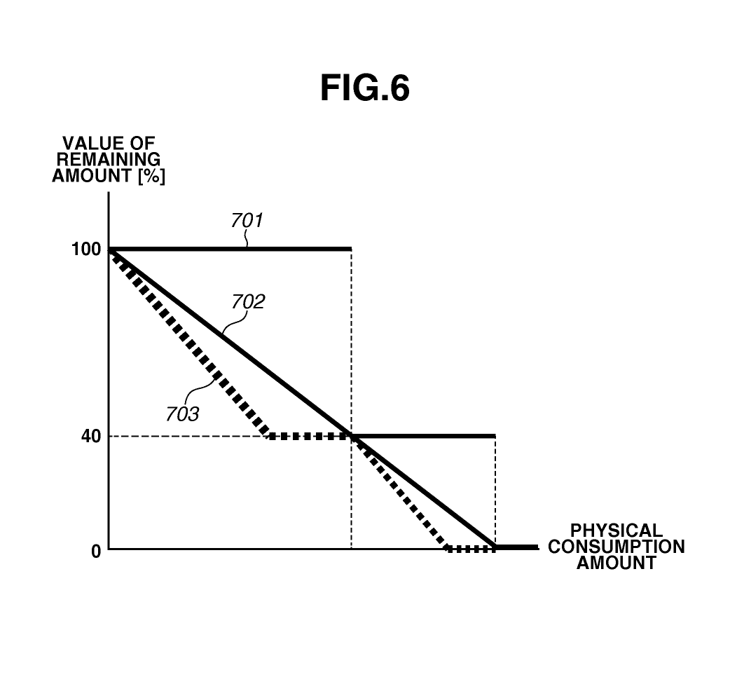

FIG. 6 is a graph illustrating transition of the current value of the remaining toner amount.

A line 701 represents a value that can be acquired as the sensor value. In the present exemplary embodiment, values 100%, 40%, and 0% can be acquired as the sensor value.

A line 702 represents transition of the actual remaining toner amount. The actual remaining toner amount is an exact value of the actual amount of the remaining toner, which is extremely difficult to be acquired directly, unless the sensor detects the remaining toner amount over the entire area with extremely high accuracy.

A dashed line 703 represents transition of the current value.

FIG. 7 (including FIGS. 7A and 7B) is a flowchart illustrating the processing of calculating the prediction value of the toner consumption amount in detail according to the present exemplary embodiment.

First, in step S301, the CPU 401 checks a type of the job received in step S105. The type of the job can be identified by information indicating a job type included in a header of the job.

Subsequently, in step S302, the CPU 401 determines whether the job type checked in step S301 is a report print job. In the report print job, various setting values set in the apparatus, software version information, and the like are output as a report. The processing proceeds to step S303 when the result of the determination in step S302 is YES, and proceeds to step S304 when the result is NO.

In step S303, the CPU 401 determines A as the toner consumption coefficient.

In step S304, the CPU 401 determines whether the job type checked in step S301 is a FAX job. In the FAX job, an image received by FAX is printed. The FAX job and the report print job are different in printed contents, but both of them basically include monochrome text data. The processing proceeds to step S305 when the result of the determination in step S304 is YES, and proceeds to step S306 when the result is NO.

In step S305, the CPU 401 determines B as the toner consumption coefficient.

In step S306, the CPU 401 determines whether the job type checked in step S301 is a copy job. In the copy job, the scanner 304 reads a document and the print engine 303 executes copying. Unlike the report print job and the FAX job, the copy job includes color data as well as monochrome data. The data size is large in a case where an image object such as a photograph is included, and is small in a case where only text data is included. The processing proceeds to step S307 when the result of the determination in step S306 is YES, and proceeds to step S314 when the result is NO.

In step S307, the CPU 401 determines whether the job includes color image data. The processing proceeds to step S308 when the result of the determination in step S307 is YES, and proceeds to step S311 when the result is NO.

In step S308, the CPU 401 determines whether the data size of the image data in the job is larger than a predetermined value. The processing proceeds to step S309 when the result of the determination in step S308 is YES, and proceeds to step S310 when the result is NO.

In step S309, the CPU 401 determines C as the toner consumption coefficient.

In step S310, the CPU 401 determines D as the toner consumption coefficient.

In step S311, the CPU 401 determines whether the size of the image data in the job is larger than the predetermined value. The processing proceeds to step S312 when the result of the determination in step S311 is YES, and proceeds to step S313 when the result is NO.

In step S312, the CPU 401 determines E as the toner consumption coefficient.

In step S313, the CPU 401 determines F as the toner consumption coefficient.

When the result of the determination in step S306 is NO, the type of the job is the print job, in which the image is printed based on the PDL data transmitted from the data processing apparatus 101. The print job includes color data as well as monochrome data, as is the case with the copy job, and thus includes various types of data that can be large or small in size.

In step S314, the CPU 401 determines whether the job includes the color image data. The processing proceeds to step S315 when the result of the determination in step S314 is YES, and proceeds to step S318 when the result is NO.

In step S315, the CPU 401 determines whether the data size of the image data in the job is larger than the predetermined value. The processing proceeds to step S316 when the result of the determination in step S315 is YES, and proceeds to step S317 when the result is NO.

In step S316, the CPU 401 determines G as the toner consumption coefficient.

In step S317, the CPU 401 determines H as the toner consumption coefficient.

In step S318, the CPU 401 determines whether the data size of the image data in the job is larger than the predetermined value. The processing proceeds to step S319 when the result of the determination in step S318 is YES, and proceeds to step S320 when the result is NO.

In step S319, the CPU 401 determines I as the toner consumption coefficient.

In step S320, the CPU 401 determines J as the toner consumption coefficient.

Subsequently, in step S321, the CPU 401 extracts the number of pages of the image data in the job received in step S105.

Subsequently, in step S322, the CPU 401 calculates the prediction value of the toner consumption amount based on the number of pages extracted in step S321, and the toner consumption coefficient determined in steps S302 to S320. More specifically, the prediction value is calculated by Equation 1.

Cₚ=Aₚ×P Equation 1

where Cₚ represents the prediction value [g] of the toner consumption amount, Aₚ represents the toner consumption coefficient (the amount of toner used per page) [g/page], and P represents the number of pages [page].

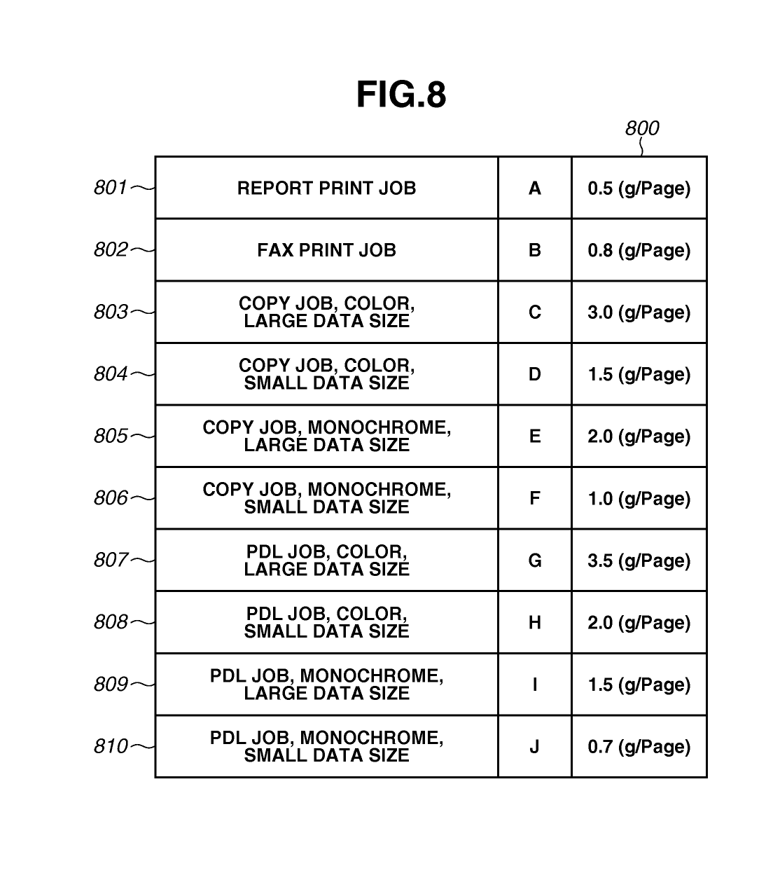

FIG. 8 is a table illustrating a correspondence relationship between the job type and the toner consumption coefficient according to the present exemplary embodiment.

The ROM 402 stores the data of the table. In steps S302 to S320, the toner coefficient is determined in accordance with the job type, based on the table.

The entire data 800 of the table includes toner coefficients 801 to 810, each corresponding to one of job types. The values may be fixed to the default values indicated in FIG. 8, or may be arbitrarily changed by the user via the UI 301 or the like.

The toner consumption amount per page differs depending on a job type, whether included image data is color or monochrome, whether a data size is large or small, or other factors. This point is focused in the present exemplary embodiment, and the toner consumption coefficients 801 to 810 are selectively used in accordance with the job type, whether the included image data is color or monochrome, whether the data size is large or small, or other factors. For example, the copy job and print job tend to include more images besides texts than the report print job and the FAX job. Thus, in the default setting, toner consumption coefficients of the copy job and the print job are set to be larger than those of the report print job and the FAX job. A job including color image data tends to include more images that consume more toner such as a photograph, compared with a job including monochrome image data. Thus, in the default setting, the toner consumption coefficient of the job including color image data is set to be larger than that of the job including the monochrome image data. A job including image data of a large data size before rasterizing tends to have more dots than a job including image data of a small data size before the rasterizing. Thus, in the default setting, the toner consumption coefficient of the job including image data of a large data size before the rasterizing is set to be larger than that of the job including image data of a small data size before the rasterizing. In addition, as another aspect which may be taken into consideration, a toner consumption coefficient different from those described above may be used if a job is received from a mobile terminal, for example.

According to the present exemplary embodiment, the toner consumption coefficient is determined in accordance with the job type, which can improve accuracy in the processing of predicting the toner consumption amount based on the number of pages in a job.

In the first exemplary embodiment, the prediction value of the toner consumption amount is always calculated based on the number of pages in a job.

A second exemplary embodiment is different from the first exemplary embodiment in that when a job includes information indicating a dot count value of image data, the prediction value of the toner consumption amount is calculated based on the dot count value. Thus, the second exemplary embodiment is supposed to be applied to a system in which the data processing apparatus 101 rasterizes the PDL data to generate raster data, and the image forming apparatus 102 can execute the image forming by receiving the raster data.

The main configuration according to the present exemplary embodiment is similar to that described with reference to FIGS. 1 to 6, and thus description thereof will be omitted.

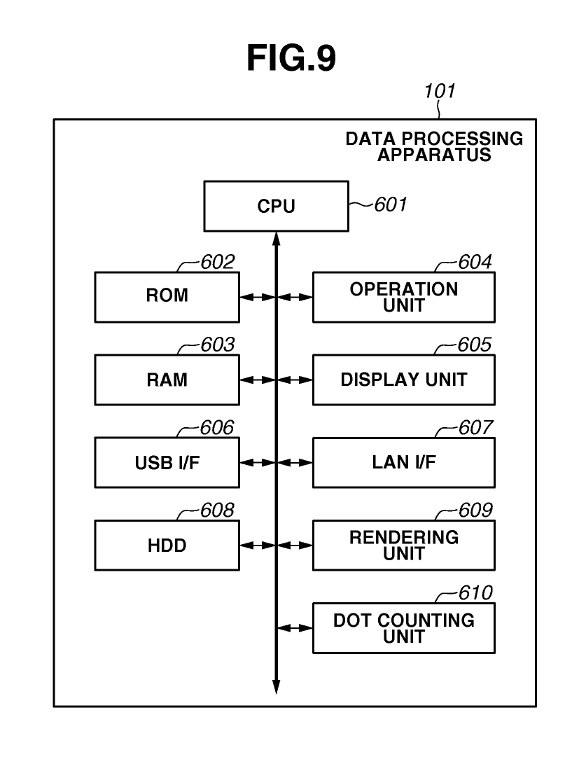

FIG. 9 is a block diagram illustrating a configuration of the data processing apparatus 101.

A CPU 601 executes various types of processing performed by the data processing apparatus 101.

A ROM 602 stores various control programs and initial setting values of the data processing apparatus 101.

A RAM 603 functions as a work area for the data processing apparatus 101 for performing various types of processing. Software of the data processing apparatus 101 is stored in the RAM 603 to be executed.

An operation unit 604 monitors an input via an input device such as a keyboard and a mouse connected to the data processing apparatus 101 and notifies the CPU 601 of input information.

A display unit 605 performs output to an output device such as a display according to control by the CPU 601.

A universal serial bus (USB) I/F 606 enables USB connection with an external apparatus.

A local area network (LAN) I/F 607 enables LAN connection with an external apparatus. A wide local area network (WLAN) I/F may be further provided to enable wireless LAN (WLAN) connection with an external apparatus.

A hard disk drive (HDD) 608 stores software such as an operating system (OS) and an application program.

A rendering unit 609 renders the PDL data to generate the raster data. This processing may be implemented by the CPU 601 with software.

A dot counting unit 610 counts the number of dots consuming toner when the image forming is executed, among dots included in the generated raster data. More specifically, the number of dots with colors other than white is counted. For example, the number of dots corresponding to black (K) is counted in a case of monochrome printing. The number of dots corresponding to any one of yellow (Y), magenta (M), cyan (C) and black (K) is counted in a case of color printing. This processing may be implemented by the CPU 601 with software.

In such a configuration, the data processing apparatus 101 generates a dot count job including the raster data generated by the rendering unit 609 and information indicating a dot count value measured by the dot counting unit 610.

On the other hand, the image forming apparatus 102 does not generate the raster data in step S106 when the job type is the dot count job, because the raster data has already been generated.

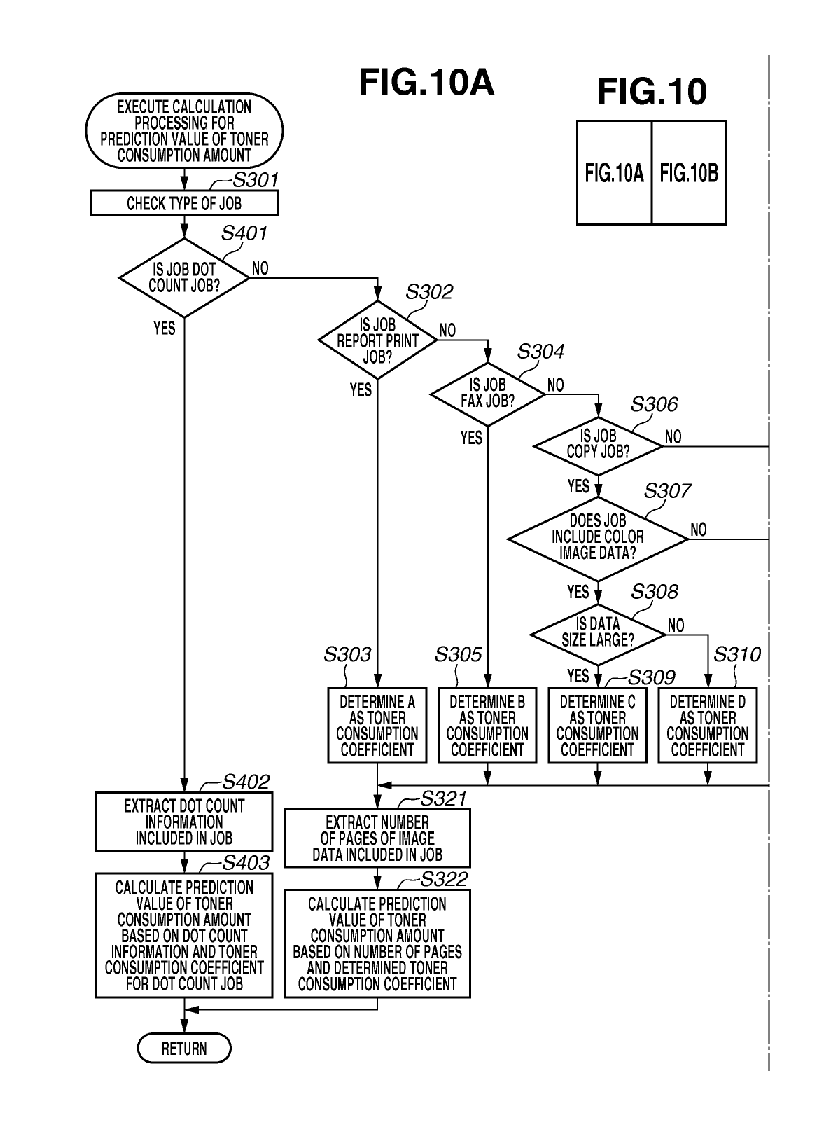

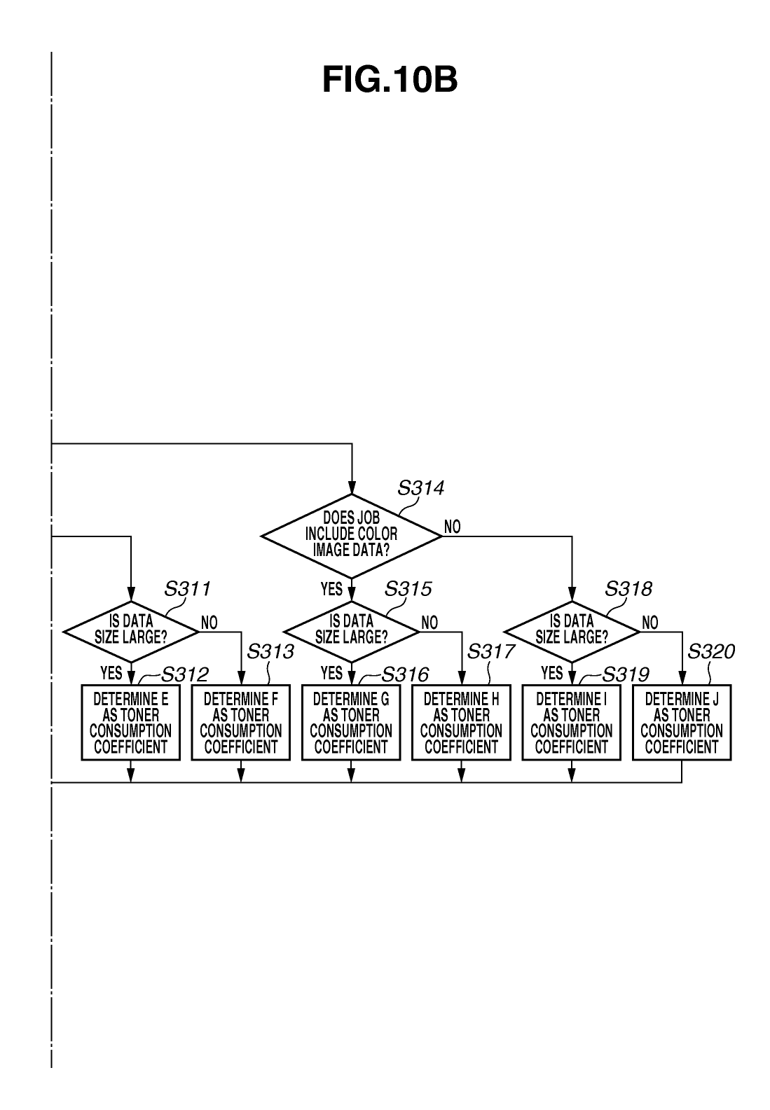

FIG. 10 (including FIGS. 10A and 10B) is a flowchart illustrating processing of calculating a prediction value of the toner consumption amount according to the present exemplary embodiment. Steps similar to those in FIG. 7 according to the first exemplary embodiment are provided with the same reference numerals and description thereof will be omitted.

In step S401 after step S301, the CPU 401 determines whether the job type checked in step S301 is the dot count job. The dot count job, which is one type of printing job, includes the raster data and the information indicating the dot count value. The processing proceeds to step S402 when the result of determination in step S401 is YES, and proceeds to step S302 when the result is NO.

In step S402, the CPU 401 extracts the information indicating the dot count value of the image data in the job received in step S105.

Subsequently, in step S403, the CPU 401 calculates the prediction value of the toner consumption amount based on the information indicating the dot count value of the image data extracted in step S402 and a toner consumption coefficient 900 for the dot count job. More specifically, the prediction value is calculated by Equation 2.

C_{d}=A_{d}×D Equation 2

where C_{d} represents the toner consumption amount [g], A_{d} represents the toner consumption coefficient (the amount of toner used per 1 K dot), and D represents the dot count value [K dot].

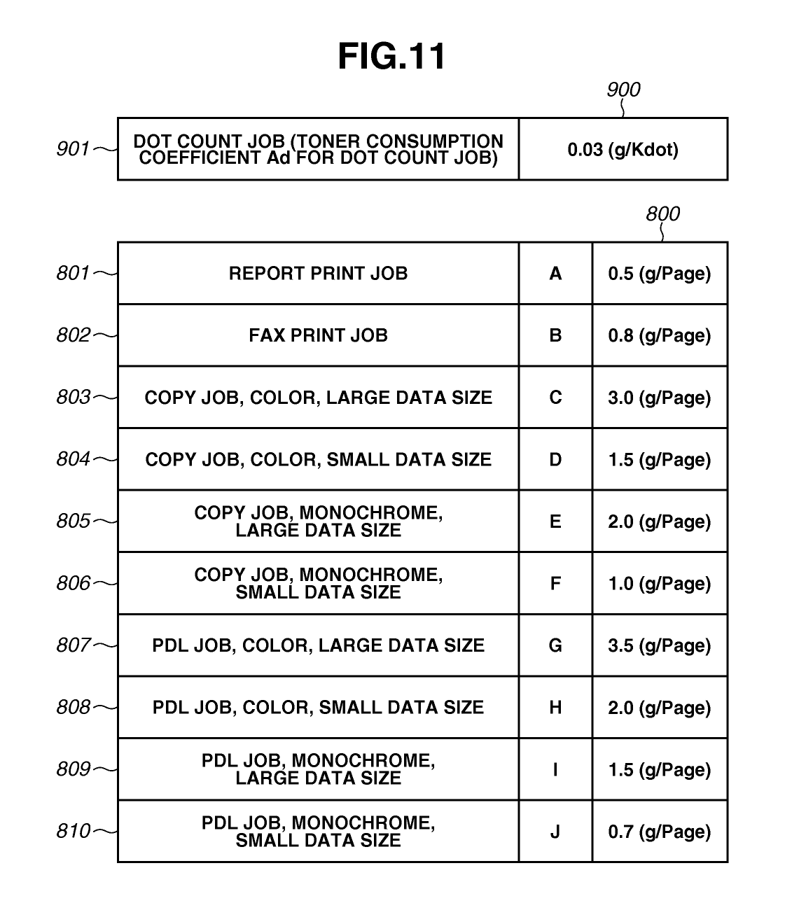

FIG. 11 is a table indicating a correspondence relationship between the job type and the toner consumption coefficient according to the present exemplary embodiment. Portions that are similar to those in FIG. 8 according to the first exemplary embodiment are provided with the same reference numerals and description thereof will be omitted.

The data of the table is stored in the ROM 402.

The value of the toner consumption coefficient 900 for the dot count job may be fixed to the value in FIG. 11, or may be arbitrarily changed by the user via the UI 301 or the like.

In the present exemplary embodiment, when a job includes the information indicating a dot count value of image data, the prediction value of the toner consumption value is calculated based on the dot count value. This can further improve accuracy in the processing of predicting the toner consumption amount.

In the second exemplary embodiment, the toner consumption coefficient is basically a fixed value.

A third exemplary embodiment is different from the second exemplary embodiment in that the toner consumption coefficient is updated based on dot count information in the dot count job.

In a case of the dot count job, the data processing apparatus 101 can recognize an object included in the job by the rendering unit 609 and can acquire the dot count information for each object by the dot counting unit 610. The object indicates an attribute of data such as a text, a graphic, and an image. Using this attribute, the following control is executed.

For example, the data processing apparatus 101 calculates an average value of dot count values of image data including only texts. The image forming apparatus 102 acquires the value from the data processing apparatus 101, and updates the toner consumption coefficient of the report print job or the FAX job (job including only texts) with the average value.

For example, the data processing apparatus 101 calculates a tendency of the number of dots for each object (the number of dots depending on the type and the number of object), in image data including various objects. The image forming apparatus 102 acquires the resultant value from the data processing apparatus 101, and updates the toner consumption coefficient of the copy job or the print job (job including various objects) using the value. The image forming apparatus 102 may newly generate and use the toner consumption coefficient for each object.

Alternatively, for example, the data processing apparatus 101 may calculate an average value of the dot count values for each user. The image forming apparatus 102 may acquire the value from the data processing apparatus 101, and newly generate and use the toner consumption coefficient for each user.

In the present exemplary embodiment, the toner consumption coefficient is updated based on the dot count information in the dot count job, which can further improve accuracy in the processing of predicting the toner consumption amount.

Additional embodiments can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2013-251396, filed Dec. 4, 2013, which is hereby incorporated by reference herein in its entirety.

What is claimed is:

1. An image forming apparatus configured to execute image forming by using a recording material, the image forming apparatus comprising:
an input unit configured to input a job;
a checking unit configured to check a type of the job input by the input unit;
a determination unit configured to determine a coefficient used to calculate a prediction value of an amount of the recording material consumed in the job, in accordance with the type of the job checked by the checking unit;
an extracting unit configured to extract a number of pages on which the image forming is executed in the job input by the input unit; and
a calculation unit configured to calculate, based on the number of pages extracted by the extracting unit and the coefficient determined by the determination unit, the prediction value of the amount of the recording material consumed in the job.

2. The image forming apparatus according to claim 1, wherein the calculation unit is configured to calculate, based on the prediction value of the amount of the recording material consumed, a prediction value of a remaining amount of the recording material in a containing unit.

3. The image forming apparatus according to claim 2, further comprising a display unit configured to display the prediction value of the remaining amount of the recording material calculated by the calculation unit.

4. The image forming apparatus according to claim 1, wherein the recording material is toner.

5. A method for controlling an image forming apparatus configured to execute image forming by using a recording material, the method comprising;
inputting a job;
checking a type of the input job;
determining a coefficient used to calculate a prediction value of an amount of the recording material consumed in the job, in accordance with the checked type of the job;
extracting a number of pages on which the image forming is executed in the input job; and
calculating, based on the extracted number of pages and the determined coefficient, the prediction value of the amount of the recording material consumed in the job.

6. A computer readable storage medium storing computer executable instructions for causing a computer to execute a method of controlling the image forming apparatus, the method comprising:
inputting a job;
checking a type of the input job;
determining a coefficient used to calculate a prediction value of an amount of the recording material consumed in the job, in accordance with the checked type of the job;
extracting a number of pages on which the image forming is executed in the input job; and
calculating, based on the extracted number of pages and the determined coefficient, the prediction value of the amount of the recording material consumed in the job.
